(19) United States
(12) Patent Application Publication
(10) Pub. No.: US 2008/0135378 A1
(43) Pub. Date: Jun. 12, 2008

(54) Sorting and Distributing System and Method For Transmitting Power and Data

(76) Inventor: Paolo Mignano, Bellinzago Novarese (IT)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 11/660,244

(22) PCT Filed: Aug. 1, 2005
(86) PCT No.: PCT/EP05/53740

§ 371 Date: Sep. 28, 2007

(30) Foreign Application Priority Data
Aug. 17, 2004 (EP) 04019520.8

(51) Int. Cl. B65G 17/34; B65G 47/94

(52) U.S. Cl. 198/370.06; 191/10

(57) ABSTRACT

The invention relates to a sorting and distributing system and to a method for transmitting power and data in a sorting and distributing system, comprised of carriages (1), which are coupled to one other to form a train (2) and which can be displaced along running rails, and comprising primary parts (5), which are arranged in a stationary manner along the running rails, serve to provide power to the carriages (1), and which can be inductively connected to secondary parts (6) provided on the carriages (1), and comprising devices for wirelessly transmitting control data for the train (2). The aim of the invention is, with the use of simple and retrofittable means, to attain a high speed and acceleration of the carriages with a low power consumption and to render a rapid and reliable data transfer possible. To this end, the invention provides that the primary parts (5) are placed at intervals along the running rails, and the secondary parts (6) can be moved past the primary parts (5) while in inductive range.

The invention concerns a sorting and distributing system as well as a method for transmitting power and data in a sorting and distributing system, consisting of carriages, which are coupled to one another to form a train and which can be displaced along running rails, each of them having at least one carrier arranged thereon for the goods being transported, and means to hand off the goods being transported at a predetermined unloading point transversely to the direction of transport of the carriages, and with primary parts, which are arranged in a stationary manner along the running rails, serving to provide power to the carriages, and which can be inductively connected to secondary parts provided on the carriages, and comprising devices for wirelessly transmitting control data for the train.

Sorting and distributing systems of the described kind have long been used for the transporting and sorting of piece goods, such as packets, parcels, containers and luggage. The carriages of the known systems are tilting tray sorters outfitted with carrying trays, which take up the goods being transported and which can swivel by means of a tilting mechanism to hand off the goods to a predetermined unloading point, in order to eject the goods transversely to the transport direction of the train. In the case of transverse conveyor belts, the carriers for the goods being transported are configured as conveyor belts, arranged on each carriage and able to be driven transversely to the direction of transport of the train, being driven in a circuit at the unloading point in order to discharge the goods transversely to the conveyor path.

It is known to provide power to sorting and distributing systems of the above-described kind by connecting electrical wires to stationary current busbars laid along the travel path of the carriages. Slip contacts connect the respective carriage to the current busbars and thus to the power source, so that an electric drive provided on the carriage can be supplied with electric current during the travel motion.

Since the current collectors must remain in constant pressing contact with the contact wires, the contact wires and also the contacts are subject to considerable wear. This leads to extensive maintenance of the system with corresponding down time, which is often unacceptable.

Therefore, solutions have been sought to minimize the wear and the maintenance and it has been proposed to undertake an inductive, or noncontact, transmission of power between a stationary current busbar (primary part) and the secondary part located on the carriage (DE 198 45 527 A1). The current busbar energized with alternating voltage receives both propulsive power for the carriages to energize the electric motors and also control-relevant electrical information, which is separated or filtered out on the carriage after the inductive power transmission. The known solution advises that the inductive power transmission take place in the middle frequency range at around 25 kHz. The alternating voltage transmitted is changed into a d.c. voltage on the carriage. In this known solution, it is considered to be a drawback that the high energy supplied to the current bars laid along the supply route leads to substantial electrical smog in the vicinity of the current bars. Furthermore, high power losses during the current transmission reduce the installed power, and because of the modulation and filtering, the transmission of control data can take relatively long and be subject to malfunction.

The object of the present invention is to improve a sorting and distributing system with inductive power transmission such that, with the use of simple and retrofittable means, a high speed and acceleration of the carriages is attained with a low power consumption and a rapid and reliable data transfer between a central computer controlling the system and the train carriages being controlled is rendered possible. This should largely avoid the environmentally hazardous electrical smog.

As the solution for the problem, it is proposed that the primary parts be spaced from each other at intervals along the running rail, and the secondary parts can be moved past the primary parts while in inductive range. One feature of the invented solution consists in that, instead of having a continuous current busbar for the inductive power supply of the carriages, one now arranges individual primary parts with lateral distances between each other along the travel rail. This solution makes it possible to transmit the power to the secondary parts of a carriage only when it is in the immediate vicinity of the primary parts and moving past them. No unnecessary dispersion occurs when primary part and secondary parts of the carriages are directly opposite each other, such as would lead to creation of electric smog.

In order to reduce the transfer points for the power being transmitted and to supply all the carriages of a group, according to another feature of the invention, the secondary parts provided on the carriages for several carriages forming a group are connected to each other via a power and/or data bus. Thanks to the data bus, one preserves compatibility with the previous communication architecture; the serial line connecting all carriages is preferably led to a carriage designated as the master vehicle of the group of carriages.

According to the invention, the largest possible distance between two neighboring primary parts is less than half the length of a train. If, for example, a train consists of 32 identical carriages, then according to the notion of the invention, at least two of the primary parts should always be involved in the power transmission. In any case, however, one should make sure that an uninterrupted power supply is guaranteed even with the small number of primary parts. Not even the malfunctioning of one primary part should impair the functional capability of the system.

Preferably, therefore, each primary part extends parallel to the running rail for such a length that two secondary parts are always at least partly in inductive range. In this way, one makes sure that no energy supply gaps arise, because two neighboring carriages are always being supplied.

In order to achieve the greatest possible efficiency in the power transmission, according to another feature of the invention, the open distance between the primary and secondary parts should be 1 mm to 5 mm, preferably 3 mm.

According to an especially important feature of the invention, the wireless transmission of control data for the train occurs by an electromagnetic wave between a sending antenna provided on the primary part and a receiving antenna provided on the secondary part. This eliminates the elaborate filtering of the mixed signal, which in the prior art transmits both the power supply energy and the data signal without contact.

According to the invention, each of the primary parts has a power mains rectifier connected in series to an inverter for the frequency transformation, and also at least one transmitter hooked up to the output of the inverter for the power supply of the carriages. With these components, the mains voltage of, say, 350 V to 500 V and a frequency of 50 Hz to 60 Hz is at first converted into a direct current and then transformed into alternating current with higher frequency, which is needed for the inductive power supply of the particular secondary part of a carriage in range with high efficiency, since the inductive gap losses also decrease with higher selected frequency.

According to another feature of the invention, a converter transforms the available control data for the train into a wirelessly transmittable signal format. For this, the control data present, e.g., in the RS485 format is converted into a FSK-modulated radio signal, making possible transmission speeds up to 19200 Baud. The radio signal is relayed to the secondary part of the closest carriage at the same time as the modulated power supply voltage.

The carrier signal, which the sending antenna puts out for the data transmission is, according to one proposal of the invention, between 1 and 10 MHz, preferably 5 MHz. According to the invention, the control data is frequency-modulated onto this carrier signal.

It has found to be especially favorable for the alternating voltage produced by the inverter of the primary part to be as high as possible. Therefore, according to the invention, it is proposed to adjust a frequency of preferably 100 kHz. At this frequency, a transmission power between 1 kW and 4 kW can be achieved with no problem.

According to the invention, each of the secondary parts contains a transceiver and a series-connected rectifier, as well as a demodulator for converting the electromagnetically transmitted control signal into a control signal which can be processed by the system, in particular into the originally existing data transmission signal. The inductively transmitted power supply voltage of around 100 kHz is converted in the rectifier into the d.c. voltage of, say, 65 V, which is used by the system, and provided to all of the carriages of a train. At the same time, the demodulator converts the electromagnetic signal beamed out by the sending antenna and received by the receiving antenna (for example, 19200 Baud/5 MHz) into the system format, as a rule into the format in which the data were originally furnished to the primary part. The data information can now be relayed via the serial lines to the neighboring carriages of the train.

Since the energy requirement will fluctuate according to the different loads on the carriages or train, in order to avoid power outages in the system, it is proposed to have data transmission means between carriage or train and the primary part lying within inductive range, by which the power volume being transmitted is regulated as a function of the current load of the carriage and/or train. With a feedback circuit, the particular power requirement can be compared to the power currently available and if there is a discrepancy in the setpoint values, the power being transmitted from the primary part to the secondary part can be increased or decreased.

It is advantageous for the mains power rectifier to be provided in a housing arranged outside of the running rails and for the inverter, the transmitter, and the controller to regulate the power volume being transmitted to be provided in a housing arranged inside the running rails. The system can be adapted to different available mains power voltages by replacing only the mains power rectifier.

A method according to the invention for power and data transmission in a sorting and distributing system with primary parts arranged at intervals along the running rail and secondary parts moving past the primary parts in inductive range calls for converting the lower frequency voltage power supply of the respective primary part at first into a d.c. voltage and then back to an alternating voltage of higher frequency, which after inductive transmission with low losses is rectified to a lower power supply voltage in the secondary part. Preferably at the same time as the inductive transmission, the available control data are frequency-modulated onto the carrier signal, electromagnetically transmitted to the carriage, and demodulated there into a data transmission signal able to be processed by the system, especially into the originally existing one.

It is of special advantage, according to the method of the invention, for the inverter to always be wirelessly controlled by a feedback loop so that the difference between a setpoint value of the power supply voltage and the actual voltage resulting as a function of the load is equalized, so that different loads on the carriages of the train have no influence.

The system and the method of the invention have a number of benefits over the prior art. Thus, the system is largely maintenance-free and secure against unintentional touching of electric contacts. Speeds and accelerations can be adjusted in broad limits, the power can be modulated and adapted to the workload of the conveyor. The transmission of control data occurs with very high transmission speeds and with more favorable circuitry. The voltage drop occurring at the current busbar in inductive systems is reduced according to the invention in that only defined power supply points are provided along the conveyor path. Furthermore, the system is very easily integrated into existing systems, or it can replace existing systems, such as contact wires.

A sample embodiment of the invention is represented in the drawing and shall be described hereafter. This shows:

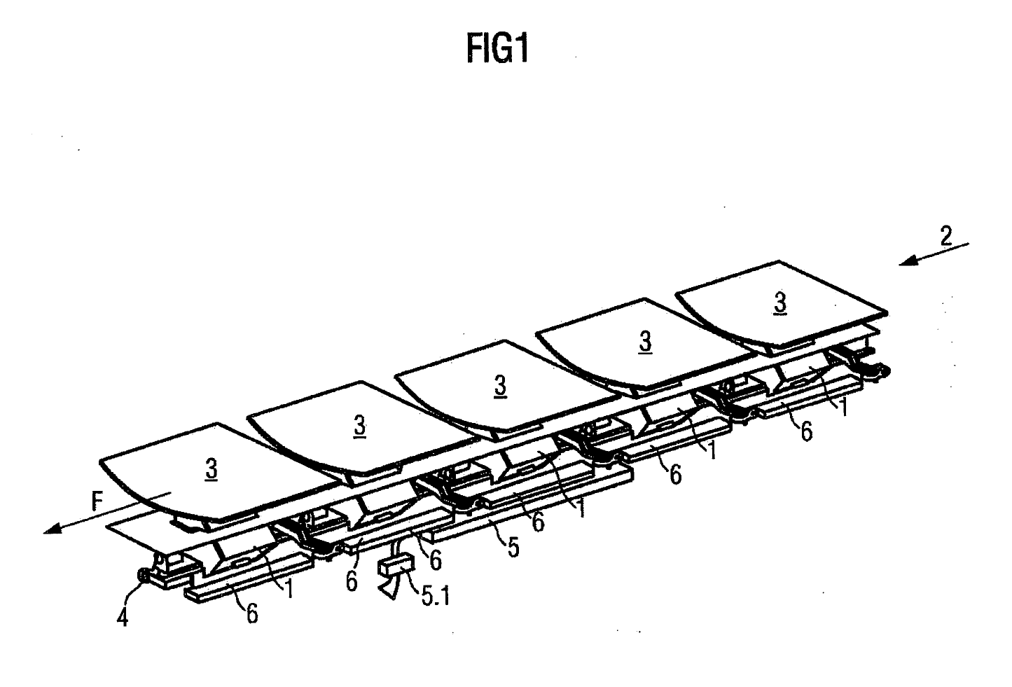

FIG. 1, in perspective view, a train made up of several coupled carriages in a system according to the invention,

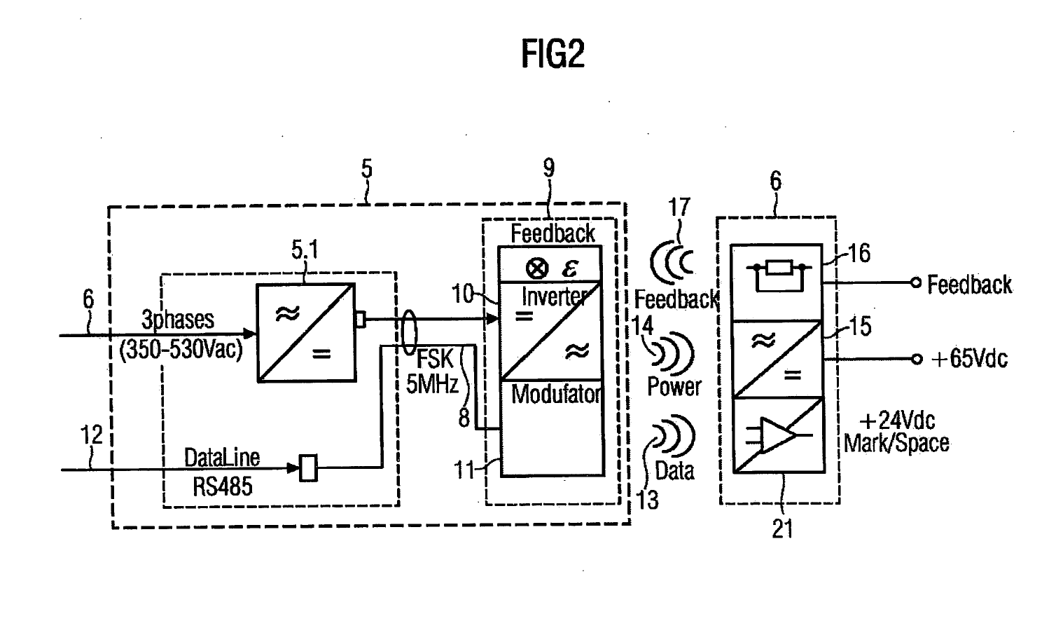

FIG. 2, the circuit of the components of the invented system in graphical representation,

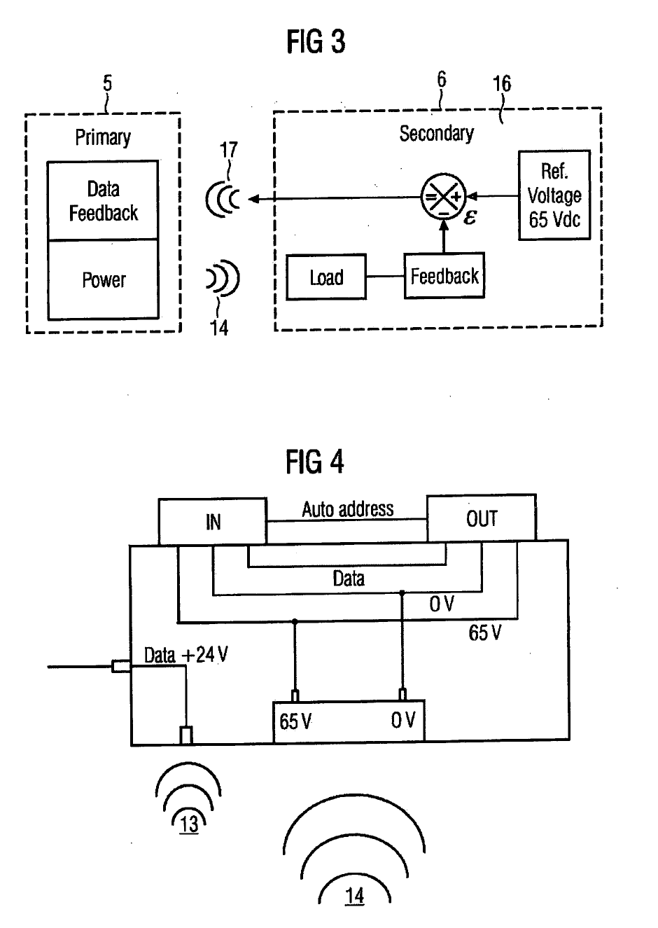

FIG. 3, the feedback circuit between secondary and primary part, and

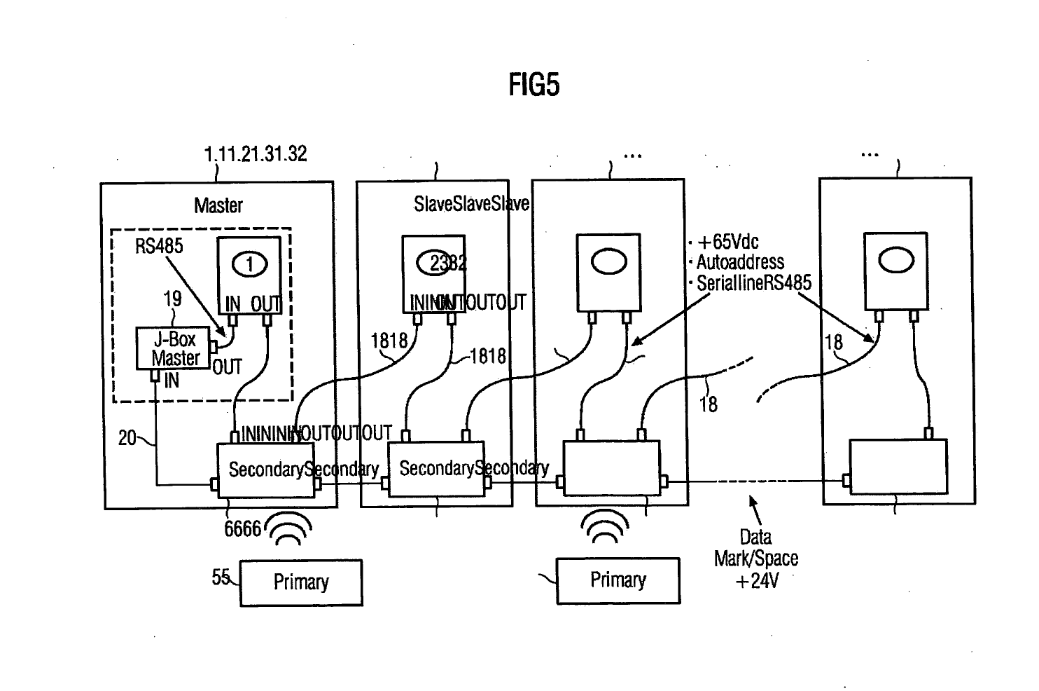

FIG. 4, the secondary part of the invention in detail view

FIG. 5, the system architecture of the invented system.

FIG. 1 shows in perspective view a train 2 of a sorting and distributing system according to the invention, consisting of five carriages 1 coupled together. Each carriage 1 holds a carrier 3 on its upper surface, which can be tilted about a swivel axis oriented in the direction of conveyance F and forms a tilting tray to accommodate the goods being transported (not shown). The carriages 1 are coupled to each other by couplings 4, so that a train is formed, which can consist of up to 32 carriages 1. All carriages 1 are guided on a common running rail, alongside which at rather large lateral distances from each other are arranged the primary parts 5 for the inductive power supply of the carriages 1, only one of which is depicted in FIG. 1. The primary parts 5 correspond with the secondary parts 6 assigned to each carriage 1, which, when the train 2 is traveling, move past the primary parts 5 at a very close interval (3 mm) within induction range. As can be appreciated, the primary part 5 and the secondary parts 6 are stretched out in length, with the primary part 5 being longer than each of the secondary parts 6. In this way, at least two secondary parts 6 are always at least partly opposite a primary part 5 in each travel position of the train 2. A rectifier belonging to the primary part 5 and designated as 5.1 is arranged outside of the running rails of the train 2 and converts the mains voltage provided there into d.c. voltage.

FIG. 2 shows the circuit of the individual components of the system according to the invention. As can be recognized at the left side of the picture, at 6 a three-phase alternating voltage of 350 V and 50 Hz is supplied to the rectifier 5.1 of the primary part 5, arranged outside of the running rails of the train. This is converted in the rectifier 5.1 into a d.c. voltage and taken across a maximum 1.5 m long cable 7 along with a control signal 8 to a box 9 arranged inside the running rail, in which an inverter 10 and modular windings are also arranged. The inverter 10 converts the d.c. voltage supplied via the line 7 into a 100 kHz alternating voltage. The control signal coming from a central computer (not shown) by a data line 12 is converted into a frequency-modulated radio signal of 5 MHz, before it is transmitted across the common line 7 to the box 9 containing the inverter 10. From here, the FSK radio signal can be relayed as an electromagnetic wave 13 by a sending antenna coordinated with the primary part 5 to a receiving antenna in the secondary part 6 of the system. Alternatively, the conversion of the control data could also take place in the box 9.

The power transmission from the inverter 10 occurs inductively at 14 with a transmission power between 1 kW and 3 kW with a frequency of 100 kHz, heavily increased relative to the mains voltage, to the secondary part 6, where the received magnetic-flux produces an alternating voltage in a winding, which is rectified into a d.c. voltage of 65 V in a rectifier 15. This 65 V d.c. voltage is a first working voltage, made available on the carriage 1 of the train 2. A second working voltage of 24 V d.c. voltage is made available for the data transmission. The received electromagnetic radio signal is converted in a demodulator in the secondary part 6 into a data signal which can be processed by the system, preferably into the originally available RS485 data transmission signal.

The control signals are relayed by serial lines to the neighboring carriages of the train and distributed as shall be further explained hereafter.

Moreover, the secondary part contains a feedback loop 16, by which the inverter 10 of the primary part 5 (as indicated at 17) can be actuated as soon as a difference is recognized between a setpoint value of the power supply voltage (working voltage 65 V) and the actual voltage occurring as a function of the load. The feedback loop 16 is presented in greater detail in FIG. 3.

Between the primary part 5 and the secondary part 6, a non-contact power and data transmission takes place. The power supply and the data supply from the central computer occurs from the primary part 5 to the secondary part 6 inductively or electromagnetically at 13 and 14, respectively, while automatic control data are exchanged in the reversed direction between the secondary part 6 and the inverter 10 of the primary part 5 via the feedback loop at 17. As is illustrated by the symbols shown in the secondary part 6, the voltage difference changing as a function of the load is detected by comparing the setpoint to the actual value and sent as a signal via a wireless communication transmission (17) to a controller, acting on the inverter 10, by which the difference is corrected.

FIG. 4 shows in greater detail the circuit in the secondary part 6 of the invented system. As symbolically indicated at 14, the power inductively transmitted by the primary part 5 (not shown here) is converted in the inverter 10 into a 65 V d.c. voltage. This voltage is taken via the IN and OUT terminals across lines 18 (power bus) to the neighboring carriages 1 of the train 2. The radio signal sent out, symbolically indicated at 13, is converted into a signal which the system can read, and likewise relayed to the carriages 1 of the train 2 via the 24 V data line.

The overall system architecture is shown in FIG. 5. There are two primary parts 5 shown, from which power is transmitted wirelessly to oppositely situated secondary parts 6 of a number of carriages 1.1 to 1.32 making up a train 2. The converted power supply voltage of 65 V is distributed by line 18 to all carriages 1.1 to 1.32 of a train 2.

The first carriage 1.1 of the train 2 at the left side of the figure is configured as the master, and it is connected to a control computer via a junction box 19 across the 24 V data line (data bus) and the above-described radio link.

Starting from the junction box 19, the line 18 is fed serially through the following carriages 1, designated as slave 1.2 to 1.32 (FIG. 4), so that a communication of the junction box 19 with all carriages 1.2 to 1.32 of a train can occur. By the IN/OUT terminals, all carriages are coupled to each other in such a way that a self-addressing can occur. This occurs in that the master 1.1 of the respective train 2, to which the central computer has distributed an address via the junction box 19, automatically passes on the address information to the next carriage 1.2 when the train starts up, so that the latter configures itself. This process is repeated across the serial data line until all carriages 1.x have configured themselves with the corresponding addresses.

Data signals, such as for unloading a carriage 1, are transmitted from the primary part 5 to the secondary part 6 of any given carriage 1.x and carried to the master 1.1 in a readable data format. From there, the signal in RS485 format is taken further by the line 18 to the addressed carriage for which the unloading task is intended.

1. A sorting and distributing system, said system comprising:
carriages, said carriages being coupled to one another to form a train and adapted to being displaced along running rails, each said carriage including at least one secondary part, at least one carrier for the goods being transported, and means to hand off the goods being transported at a predetermined unloading point transversely to the direction of transport of said carriages,
primary parts, said primary parts being arranged in a stationary manner along the running rails and adapted, to provide power to said carriages, and
wireless transmitting devices, said wireless transmitting devices adapted to wirelessly transmit control data for said train;
said primary parts configured to being inductively connected to said secondary parts provided on said carriages, said primary parts being spaced from each other at intervals along the running rail, and said secondary parts configured to being moved past said primary parts while in inductive range.

2. The sorting and distributing system of claim 1, wherein said secondary parts provided on said carriages for several said carriages are connected to each other via at least one selected from a power bus and a data bus.

3. The sorting and distributing system of claim 1, wherein the largest possible distance between two adjacent said primary parts is less than half the length of said train.

4. The sorting and distributing system of claim 3, wherein each said primary part extends parallel to the running rail for such a length that two said secondary parts are always at least partly in inductive range.

5. The sorting and distributing system of claim 4, wherein the open distance between said primary and said secondary parts is approximately 1 mm to 5 mm.

6. The sorting and distributing system of claim 1, wherein said wireless transmitting devices are configured to transmit control data for said train by an electromagnetic wave between a sending antenna provided on said primary part and a receiving antenna provided on said secondary part.

7. The sorting and distributing system of claim 6, wherein each said primary parts includes a power mains rectifier connected in series to an inverter for frequency transformation, and wherein each said primary part includes at least one transmitter hooked up to the output of said inverter for the power supply of said carriages.

8. The sorting and distributing system of claim 6, further including a converter, said converter adapted to transform the available control data for said train into a wirelessly transmittable signal format.

9. The sorting and distributing system of claim 6, wherein the power transmittable inductively between said primary and said secondary parts is between approximately 1 and 4 kW.

10. The sorting and distributing system of claim 6, wherein said sending antenna for the data transmission between said primary part and said secondary part beams out a carrier signal of approximately 1 to 10 MHz.

11. The sorting and distributing system of claim 10, wherein the control data is frequency-modulated onto said carrier signal.

12. The sorting and distributing system of claim 7, wherein the alternating voltage produced by said inverter has a frequency of approximately 100 kHz.

13. The sorting and distributing system of claim 6, wherein each said secondary part contains a transceiver and a series connected rectifier, as well as a demodulator for converting the electromagnetically transmitted control signal into a control signal which can be processed by said system.

14. The sorting and distributing system of claim 1, wherein the power volume being transmitted by said primary part is regulated as a function of the current load of at least one selected from said carriage and said train.

15. The sorting and distributing system of claim 7, wherein said power mains rectifier is provided in a housing arranged outside of the running rails, and wherein said inverter, said transmitter, and a controller adapted to regulate the power volume being transmitted are provided in a housing arranged inside said running rails.

16. A method for power and data transmission in a sorting and distributing system, said method comprising:
providing carriages, said carriages being coupled to one another to form a train and adapted to being displaced along running rails;
providing secondary parts on said carriages;
providing primary parts for the power supply to the carriages, said primary parts being arranged in a stationary manner at intervals along the running rails, and which can be inductively connected to said secondary parts provided on said carriages;
providing wireless transmitting devices, said wireless transmitting devices adapted to wirelessly transmit control data for the train;
moving said secondary parts past said primary parts in inductive range; and
supplying inductively power to said carriages, said supplying power inductively comprising:
converting a lower frequency voltage power supply of the respective said primary part at first into a d.c. voltage;
converting said d.c. voltage back to an alternating voltage of higher frequency;
transmitting inductively said alternating voltage of higher frequency with low losses; and
rectifying said alternating voltage of higher frequency to a lower power supply voltage in said secondary part.

17. The method for power and data transmissions of claim 16, further comprising:
frequency-modulating control data onto a carrier signal;
transmitting electromagnetically the carrier signal to said carriage, and
demodulating the control data into a data transmission signal able to be processed by said system.

18. The method for power and data transmission of claim 16 further comprising:
providing a feedback loop;
providing an inverter; and
actuating wirelessly said inverter by said feedback loop so that the difference between a setpoint value of the power supply voltage and the actual voltage adjusted as a function of the load is equalized.

19. The method for power and data transmission of claim 17, wherein said transmitting electromagnetically the carrier signal occurs at generally the same time as said transmitting inductively said alternating voltage of higher frequency.

20. The sorting and distributing system of claim 1, wherein each said primary part includes a power mains rectifier connected in series to an inverter for frequency transformation, and wherein each said primary part includes at least one transmitter hooked up to the output of said inverter for the power supply of said carriages.
